(19) United States
(12) Patent Application Publication
(10) Pub. No.: US 2006/0022004 A1
(43) Pub. Date: Feb. 2, 2006

(54) Platform for automobile trunks

(76) Inventor: Thomas Joseph Mazzone, Auburn, AL (US)

Correspondence Address: Thomas J. Mazzone, 2238 Riverwood Dr., Auburn, AL, 36830, US

(21) Appl. No.: 10/909,943

(22) Filed: Aug. 2, 2004

(51) Int. Cl. B60R 7/00

(52) U.S. Cl. 224/311; 224/42.32

(57) ABSTRACT

A flat surface platform that is installable inside the trunk of an automobile. The platform is supported by four pedestals attached to the underside of the platform in a manner that allows it to rest on the left and right shoulders of the said trunk. The basic platform has a door with mounted hinges, a cover that rests on stops so that it lies flat, and can be firmly locked or lies flat on the platform without hinges, resting on stops, so it can be firmly fixed to the platform by rotatable wing locks so the cover can be removed and place on the top of the platform. This platform incorporates two side members that can be installed on each side, lying flat with the surface so that it blends with the contours of the internal sides of the trunk. There are two methods of installing the wings. one option uses a tab/slot design and the other option uses the action of two sliding door locks.

### DESCRIPTION OF THE PRIOR ART

The field of automobile trunks has been researched through the internet and it appears that very little effort has been put into this field by the number of patents relating to the inside of an automobile trunk. The prior art has been searched and what has been found is a few patents that are very complex and therefore very expensive to manufacture because there are too many parts to make and the assembly of the parts requires many hours to assemble.

The invention being applied for is very simple in concept and easy to make. It creates more space in the trunk since it adds another shelf with about double the previous storage space, moreover, since the storage level is much higher than the floor of the trunk, it becomes much easier for elderly people to handle the items to be storaged and transported home or wherever they are moving the items to. Most of the physical effort is reduced when the items are removed from the car since they are elevated very near the ledge of the open door.

### FIELD OF INVENTION

The invention relates to the field of making every day shopping easier for people who are handicapped or have a problem in lifting large and heavy packages if the automobile has a deep trunk. To remedy this physical problem a platform has been created for cars that have a deep trunk. To make life easier weekly shopping trips, a flat sturdy platform is herein proposed for cars that have a very deep trunk. The platform has pedestals that raises it above the floor of the trunk to a position very near the trunk body latch, thereby making the function of loading and unloading the purchased items much easier to handle.

To make efficent use of the space below the said platform a removable cover or a lid has been incorporated in the platform so that suitcases and other traveling items may be carried on the floor of the trunk. Furthermore, wings on the left and right side of the said platform have been developed to increase the useable area of the basic said platform.

### SUMMARY OF THE INVENTION

The idea of this flat platform, shelf, with a lid, door or cover is to develope it as a humanitarian endeveor to make life a little easier for the elderly people, senior citizens who have back problems, and anyone who needs help while they shop for every day necessities. A flat platform with a removable and, or hinged door is an answer to this human necessity. The platform is basically a flat shelf with a lid, with an option to add two side elements, called wings to increase the carrying area of the platform. These wings can be installed or removed to accommodate the individual situation. The affect of adding a platform of this nature to the trunk, creates a second shelf raised substantly above the trunk floor establishing easier access to transported items.

Most automobile trunks have different trunk interiors because of model differences, size and esthetic objectives of the manufacturer, however, there are several sedans made by the same company that have alike trunk interiors. This invention targets these models.

### BRIEF DESCRIPTION OF THE DRAWINGS

The drawings consist of thirteen illustrations, two of which are a cross section.

To obtain a better understanding of the nature and objects of the invention, reference is made to the following drawings, in which:

FIG. 1 is a plan view of the platform showing it as one piece with hand slots, strenghtening ribs, thin curved sections and circular holes.

FIG. 2 reveals a frontal view showing the pedestals and ribbing, and cross section A-A of the thin internal hinge.

FIG. 3 shows a side view of the platform.

FIG. 4 again shows the platform in the top view with the door in a closed and open position attached with two hinges, and a door stop, and a flexible clip to keep the door closed.

FIG. 5 shows a frontal view of the platform with the the flexible clamp holding the door down in a locked position.

FIG. 6 is a side view of FIG. 5 showing the open door.

FIG. 7 shows a top view of the platform with a cover and two cantilevers on each side of the cover acting as cover stoppers attached to the underside.

FIG. 8 is the side view of FIG. 7

FIG. 9 is the top view of the platform with wings engaged in the slots.

FIG. 10 is a view showing the tab of the wings locked to the platform and section B-B with plates on each side of the wing tabs.

### DETAILED DESCRIPTION OF THE INVENTION

FIG. 1 illustrates the top view of the platform member 1 for a vehicle trunk made from one slab of plastic material having ribbing member 10 to give it stiffness, hand held slots member 5 for improved handling, pedestals member 2 attached to the underside of the said platform for support as they rest on the shoulders, and the floor of the trunk. The platform body is member 1, and member 3 is a cross rib stiffener, while member 4 is one of a number of narrow slots to support vertical panels, member 11. The platform has other ribs, member 10 for the lid on the underside, to act as stiffeners and stops member 9 so the lid can rest in a flat position. Member 6 is the lid and member 7 is a stiffener in the middle of the lid. member 13 is the door lock.

FIG. 2 shows the platform at rest on the raised shoulders on each side of the trunk, supported by the said pedestals member 2 in contact with the floor of the trunk. Member 8 represents one of two thin elements that are cut after the platform is molded creating a lid.

FIG. 3 shows the side view of FIG. 1 with member 10 represenative of the ribbing at various locations on the underside of the said platform.

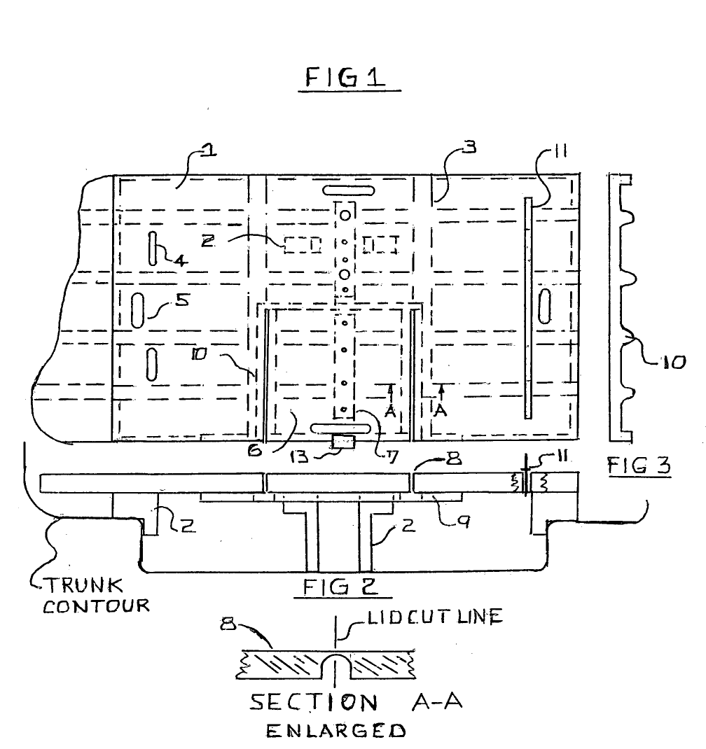

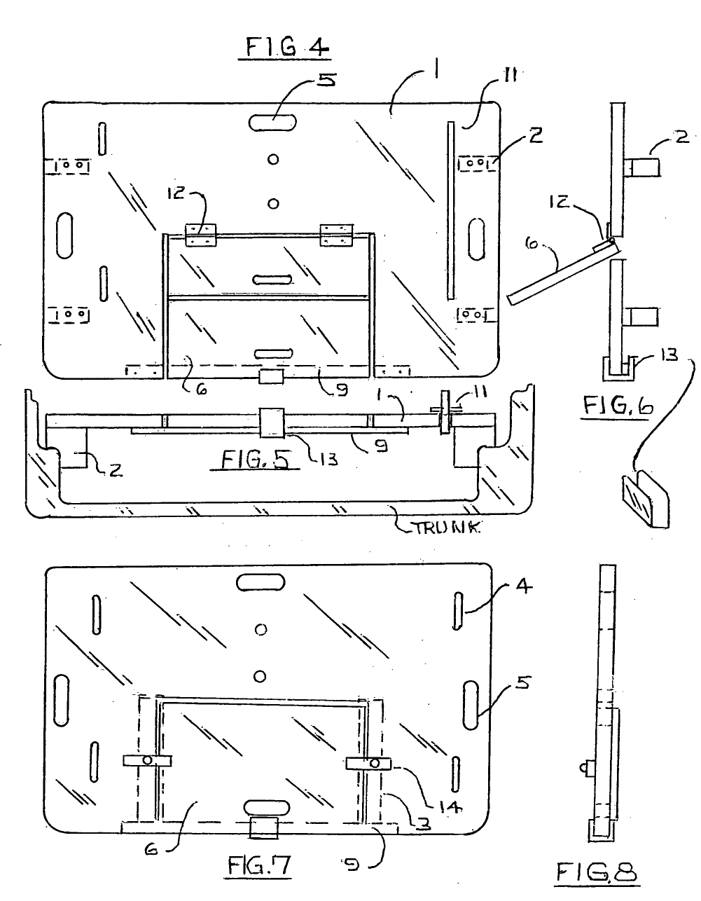

FIG. 4 showing member 1, the said platform, depicts an alternate configuration of the platform having a hinged lid member 12, one of two hinges, for door movement.

FIG. 5 is a front view of FIG. 4 showing member 13, a flexible U-shaped clip, holding the door in a closed position while the platform is seated on the shoulders of the trunk with supporting member 2. The door is also shown in the open position; and also shown in this configuration is an insert member 11 that establishes a panel to sectionalize the top surface of the platform.

FIG. 6 shows the open door member 6, and member 13 in a three dimensional position depicting the door clip.

FIG. 7 shows another option of the cover, that is removable, held downfirmly by a rotatable wing lock so that it remains in a relative flat position when the vehicle is in motion. This lock is member 14; and it can be rotated 360 degrees.

FIG. 8 is the side view of the platform plan view.

FIG. 9 is another top view of the platform having a removable door member 6 as shown in FIG. 7 with the wing type lock. The representation shows the architecture of the sides of the trunk interior and two insertable and removable elements providing additional carrying space connected to each side of the said platform. These extensions have tabs on one side of their structure that are members 15 and 16, herein, called wings. The platform member 1 has cur-outs that conform to the shape of the wing tabs; and member 17, metal plates, that are attached to the opposite sides, the top and bottom, of the platform thereby creating slots shaped to accept the tabs as shown by section B-B above the top view.

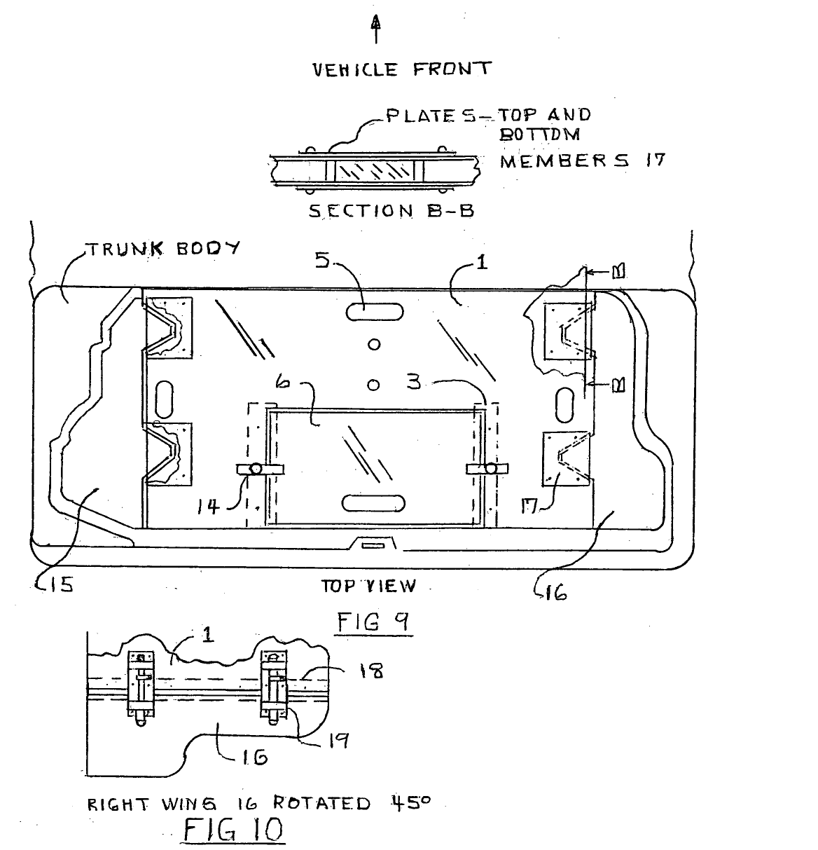

FIG. 10 reveals the details of an alternative method of attaching the wing members 15 and 16 to the platform member 1. This view shows member 16 typical of wing member 15 assembled with two slip bolts and supported by a cantilever member 18 attached to the underside of the said platform that guides the wing's installation during assembly. The bolts make the installation of the wings easier because they can be set down into place, slip the bolt into its counterpart, and rotate it to the locked position, and furthermore, tabs require more side space to insert them into slots.

What is claimed:

1. A flat platform with integrated homogeneous stiffeners, a lid having straight homogeneous integrated hinge, hand held slots and other useful slots and holes designed and configured to fit inside the trunk of a vehicle, and is removable.
A lid formed by a groove on the underside of the said platform that goes all around the outer edges of the lid, forming a three sided pattern that can be cut on the two opposing sides up to where it meets the third side, lies therein between, thereby leaving the uncut side intact with the properties of the thin section of the groove acting as one long hinge.
A platform having cantilevered stiffeners attached to the underside where grooves were cut that act as stops to keep the lid in a flat position relative to the said platform.
A left side edge member that is contoured to blend with the architecture of the inner left side of the trunk.
A right side edge that is formed with a straight edge perpendicular to the back and front edges of the said paltform.
A means of supporting the said platform with pedestals that are attached to the underside thereon, and resting on the left and right shoulders of the trunk.
A fabrication made with a plastic material.
A removable member that has tab extensions that fit into slots and stand vertical to form walls dividing the floor of the said platform into several sections.
A flexible U-shaped clip that can be inserted into the edge of the door and frame to keep the door closed.

2. A flat platform that fits inside of the trunk of an automobile and rests on attached pedestals which are supported by the archittecture of the base and shoulders of the trunk, has a lid, and is removable.
The said platform incorporates a lid that can be raised off its normal resting position, set aside, exposing an opening to the bottom of the trunk.
The said platform has cantilevered stops attached to the underside of the said platform to hold the lid in a relative flat position to the surface.
A rotatable latch fastened to the said platform to prevent the lid from bouncing up and down when the vehicle is in motion. Rotatable latches apply only to lids that can be lifted off of the platform surface.
The said platform provides hand held slots for lifting it into or out of the trunk, and other useful holes and slots.
An optional attached hinged door that can be turned about 180 degrees to open access to the bottom floor of the trunk.
A flexible U-shaped clip that can be inserted into the edge of the door and the frame to keep the door closed.
A platform whose outer sides are perpendicular to each of the adjacent sides.
Removable members that interlock with the said platform slots or holes, interchangeable with each other, and stands vertical to form panels, dividing the surface of the said platform into sections.

3. A flat platform having cut-outs on the left and right sides and flat plates on the opposite sides of the cut-out, top and bottom, fastened to each other and the said platform to create slots of a triangular shape, having a lid with hinges that opens up to the bottom of the trunk, with pedestals that support it on the shoulders of the trunk, with a configuration whose outer sides are perpendicular to each of the adjacent sides.
Members having flat extensions to the sides of the said platform, one member to the left side and one member to the right side, shaped to fit the slots, and insertable into the shaped slots of the said platform, and having shaped outer edges to blend with the individual architectural features of each side of the inner trunk, which are removable, and herein called wings.
Members having tabs, that stand vertical, performing functions as panels, insertable into slots on the said platform.
A flat platform of claim 3, having sliding door bolts attached thereon that are optional, which engage the counterpart of the bolts that are attached to the wings.
The said platform having ribs that overhang the bottom, along the connecting edges, at each side, to guide the wings into position and also strenghten the engagement.
